(19) United States
(12) Patent Application Publication
(10) Pub. No.: US 2020/0301803 A1
(43) Pub. Date: Sep. 24, 2020

(54) SYSTEMS AND METHODS FOR MULTIPLE ELEMENT SELECTION IN PERFORMANCE ANALYTICS DASHBOARD BREAKDOWN

(71) Applicant: ServiceNow, Inc., Santa Clara, CA (US)

(72) Inventors: Marta Penzo, Amsterdam (NL); Gurupada Das, Hyderabad (IN); Petrus Goris, Amsterdam (NL); Abhijith Thette Nagarajan, Amstelveen (NL); Isaak Papagiannidis, Amsterdam (NL)

(21) Appl. No.: 16/358,260

(22) Filed: Mar. 19, 2019

(51) Int. Cl. G06F 11/32; G06F 11/34

(52) U.S. Cl. CPC G06F 11/321; G06F 11/3409; G06F 11/324

(57) ABSTRACT

A performance analytics dashboard may receive a selection of multiple breakdown elements and update a visualization within the widget based on the selected breakdown elements. The widget may have an aggregate view type or a separate view type. In the aggregate view type, data associated with the selected breakdown elements is combined into a single plot. In the separate view type, data associated with the selected breakdown elements is kept separate and shown in separate respective plots.

### BACKGROUND

The present disclosure relates generally to performance analytics dashboards and, more specifically to breakdown element selection for widgets within a performance analytics dashboard.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

In modern communication networks, examples of cloud computing services a user may utilize include so-called infrastructure as a service (IaaS), software as a service (SaaS), and platform as a service (PaaS) technologies. IaaS is a model in which providers abstract away the complexity of hardware infrastructure and provide rapid, simplified provisioning of virtual servers and storage, giving enterprises access to computing capacity on demand. In such an approach, however, a user may be left to install and maintain platform components and applications. SaaS is a delivery model that provides software as a service rather than an end product. Instead of utilizing a local network or individual software installations, software is typically licensed on a subscription basis, hosted on a remote machine, and accessed by client customers as needed. For example, users are generally able to access a variety of enterprise and/or information technology (IT)-related software via a web browser. PaaS acts an extension of SaaS that goes beyond providing software services by offering customizability and expandability features to meet a user's needs. For example, PaaS can provide a cloud-based developmental platform for users to develop, modify, and/or customize applications and/or automating enterprise operations without maintaining network infrastructure and/or allocating computing resources normally associated with these functions.

A performance analytics dashboard may include multiple widgets, customizable by a user to generate and display visualizations of data. Breakdown elements may be available for selection by the user to filter and/or sort data for the visualizations. However, existing breakdown element selection capabilities may result in the user toggling between multiple widgets, and thus missing a complete understanding of the underlying data.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The disclosed subject matter includes techniques for receiving selection of multiple breakdown elements and updating a visualization within the widget based on the selected breakdown elements. The widget may have an aggregate view type or a separate view type. In the aggregate view type, data associated with the selected breakdown elements is combined into a single plot. In the separate view type, data associated with the selected breakdown elements is kept separate and shown in separate respective plots. The widget may be part of a dashboard having multiple widgets. The dashboard may include some widgets having an aggregate view type and other widgets having a separate view type.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a block diagram illustrating performance analytics and reporting (PAR) features facilitated through a homepage and/or a dashboard, in accordance with aspects of the present disclosure;

FIG. 6 is a screenshot of an embodiment of the dashboard of FIG. 5, in accordance with aspects of the present disclosure;

FIG. 7 is a screenshot of an embodiment of the dashboard shown in FIG. 6 with a breakdown element field selected, in accordance with aspects of the present disclosure;

FIG. 8 is a screenshot of an embodiment of the dashboard shown in FIGS. 6 and 7 with a software breakdown element selected, in accordance with aspects of the present disclosure;

FIG. 9 is a screenshot of an embodiment of the dashboard shown in FIGS. 6-8 with the software breakdown element selected and breakdown element field selected, in accordance with aspects of the present disclosure;

FIG. 10 is a screenshot of an embodiment of the dashboard shown in FIGS. 6-9 with the software breakdown element and a network breakdown element selected, as well as the breakdown element field, in accordance with aspects of the present disclosure;

FIG. 11 is a screenshot of an embodiment of the dashboard shown in FIGS. 6-10 with the software breakdown element, the network breakdown element, and the database breakdown element selected, in accordance with aspects of the present disclosure;

FIG. 12 is a screenshot of a widget definition interface, by which a user may define one or more aspects of the widget, including whether the widget displays an aggregate view or a separate view when multiple breakdown elements are selected, in accordance with aspects of the present disclosure;

FIG. 13 is illustrates an embodiment of a dropdown menu that appears when the breakdown element field is selected, in accordance with aspects of the present disclosure;

FIG. 14 is illustrates an embodiment of the dropdown menu that appears when the breakdown element field is selected and an “applied” option is selected in a sort bar, in accordance with aspects of the present disclosure; and

FIG. 15 is a flow chart of a process for updating the widget based on selection of breakdown elements, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used herein, the terms alerts, incidents (INTs), changes (CHGs), and problems (PRBs) are used in accordance with the generally accepted use of the terminology for CMDBs. Moreover, the term “issues” with respect to a CI of a CMDB collectively refers to alerts, INTs, CHGs, and PRBs associated with the CI.

A performance analytics systems may include a dashboard having multiple widgets, customizable by a user to generate and display visualizations of data. Breakdown elements may be selectable by the user to filter and/or sort data for the visualizations. The disclosed techniques include receiving selection of multiple breakdown elements and updating a visualization within the widget based on the selected breakdown elements. The widget may have an aggregate view type or a separate view type. In the aggregate view type, data associated with the selected breakdown elements is combined into a single plot. In the separate view type, data associated with the selected breakdown elements is kept separate and shown in separate respective plots. The widget may be part of a dashboard having multiple widgets. The dashboard may include some widgets having an aggregate view type and other widgets having a separate view type.

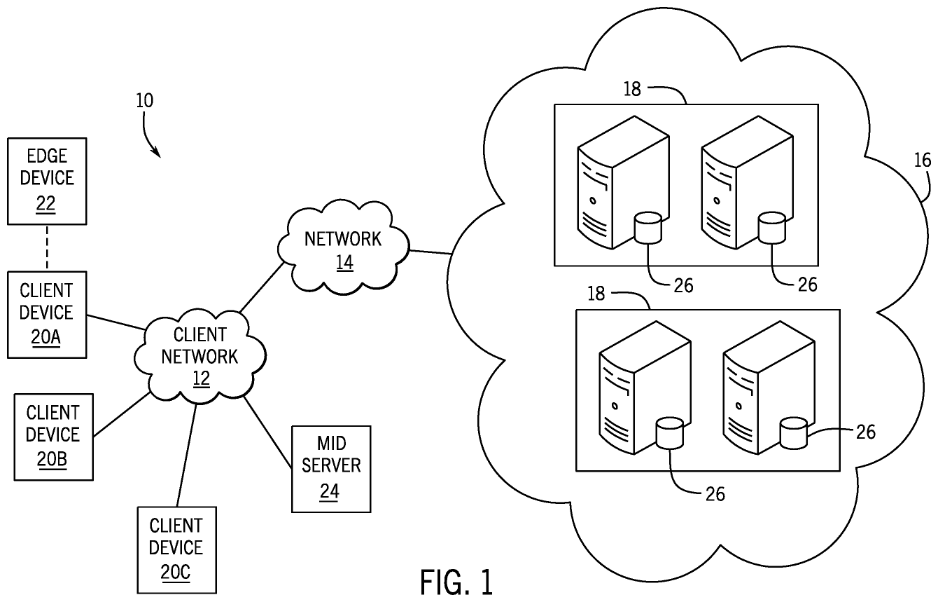

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

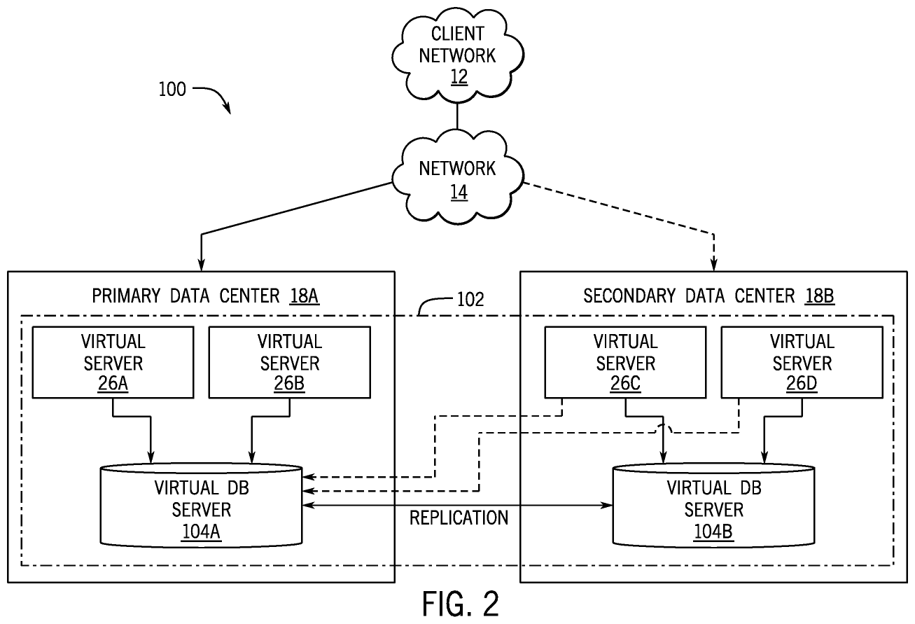

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

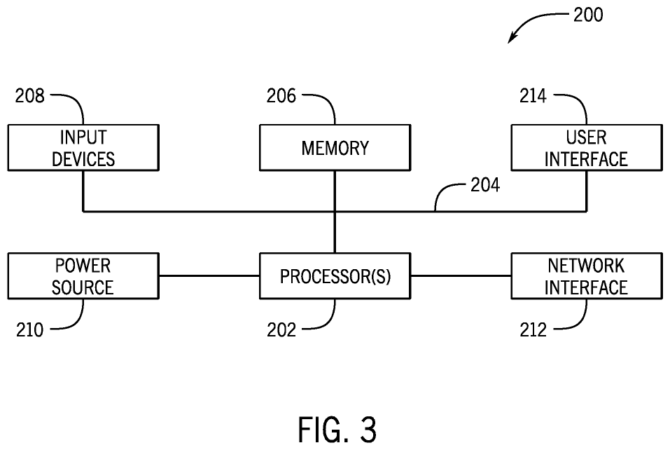

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

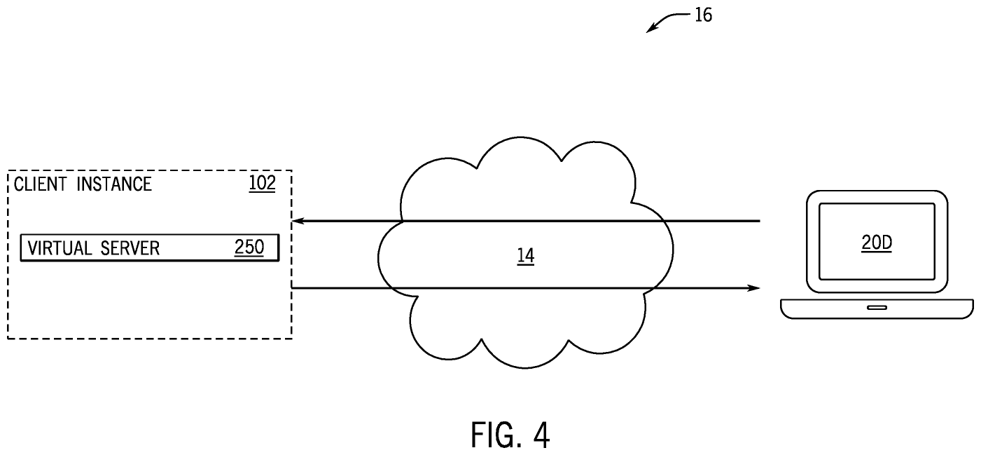

With the foregoing in mind, FIG. 4 is a block diagram illustrating an embodiment in which a virtual server 250 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20D via the network 14 to provide a user interface to network applications executing within the client instance 102 (e.g., via a web browser of the client device 20D). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

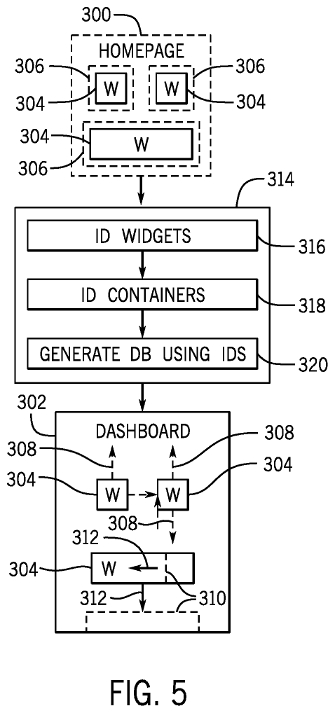

The discussion now turns to a mechanism for displaying system data via one or more visualizations, enabling interactivity with the system data, and reporting on the system data. FIG. 5 is a block diagram illustrating performance analytics and reporting (PAR) features facilitated through a homepage 300 and/or dashboard 302, in accordance with an embodiment. It should be understood, however, that the homepage 300 and dashboard 302 are merely examples and that in other embodiments, visualizations may be created for workspace environments, reports, etc. in addition to homepages and dashboards. As used herein, a “homepage” refers to a graphical-user-interface (GUI) screen where data-driven widgets 304 may be placed in pre-defined containers 306 that have a static placement and/or size. In the instant embodiment, one or more of the widgets 304 include visualizations from a shared visualization library.

In some embodiments, dashboard 302 may be it may be configured to enable customized positioning and/or sizing of widgets 304. As used herein, the term “dashboard” refers to a graphical-user-interface (GUI) screen where data-driven widgets 304 may be placed on the screen without being constrained to pre-defined containers 306 and/or static placement and/or size. In other words, for the dashboard 302, the widgets 304 may be dynamically moved to any location on the dashboard 302 without being constrained to pre-defined locations, as indicated by arrows 308. Further, the size of the widgets 304 may be dynamically altered in the dashboard 302, as indicated by sizing indicators 310 and arrows 312.

As there may be more flexibility in configuring a dashboard 302 over a homepage 300, it may be desirable in certain situations to convert a homepage 300 to a dashboard 302. Indeed, it may be burdensome to generate dashboards 302 from scratch after time and effort may have already been afforded to creating a homepage 300. Accordingly, in some embodiments, a conversion process 314 may be implemented to convert a homepage 300 to a dashboard 302.

The conversion process 314 may identify the widgets 304 found on the homepage 300 (block 316). For example, a computer-readable representation of the homepage 300 (e.g., a homepage object) may be traversed to identify each of the widgets 304 on the homepage 300.

Further, the conversion process 314 may identify the containers 306 and their associated sizes and placements for the identified widgets 304 found on the homepage 300 (block 318). For example, the computer-readable representation of the homepage 300 (e.g., a homepage object) may be traversed to identify each of the containers 306 containing the widgets 304 on the homepage 300. Position and/or size attributes of the containers 306 may be identified by accessing object attributes of the computer-readable representation of the homepage 300.

Once the widgets 304 and the containers 306 and their attributes are identified, a corresponding dashboard 302 may be generated (block 320). For example, computer instructions may generate a computer-readable representation of the homepage 300, inserting the widgets 304 at the position and/or size identified by the container 306 attributes. Once the dashboard 302 is generated, it may be accessed and the size and position of the widgets 304 may be modified dynamically.

The widgets 304 may be independent data-driven software that perform particular tasks. For example, the widgets 304 may provide visualizations generated based upon datasets of the system, such as those present within database. The widgets 304 may be selected, for example, from a library (e.g., a visualization library).

In accordance with certain aspects of the present disclosure, the widgets 304 are generated according to a guided workflow presented as a part of a graphical user interface (GUI) configured to facilitate generation of analytics and/or reporting widgets on an embodiment of the homepage or an embodiment of the dashboard. Though widgets may be created for a wide range of functions, the instant embodiments are focused on tracking incidents. Depending on the data being tracked, an “incident” may be any occurrence that a user is interested in tracking. For example, in some embodiments, an incident may be the opening of a service ticket, the number of open service tickets on a given day, a network outage, a hardware failure, a software failure, a login failure, a request for action, an unfulfilled purchase request, a security breach, a virus or malware warning, an event, a filed complaint, or any other occurrence or metric a user is interested on monitoring.

Once generated, the dashboard may receive inputs manipulating one or more of the widgets and/or visualizations. For example, the inputs may include selection of one or more breakdown elements. The breakdown elements may include various categories of the underlying data, such that selection of breakdown elements gives the user a more nuanced and comprehensive view of the underlying data. In response to the inputs, the dashboard may update the widgets and/or visualizations to reflect selection of one or more breakdown elements.

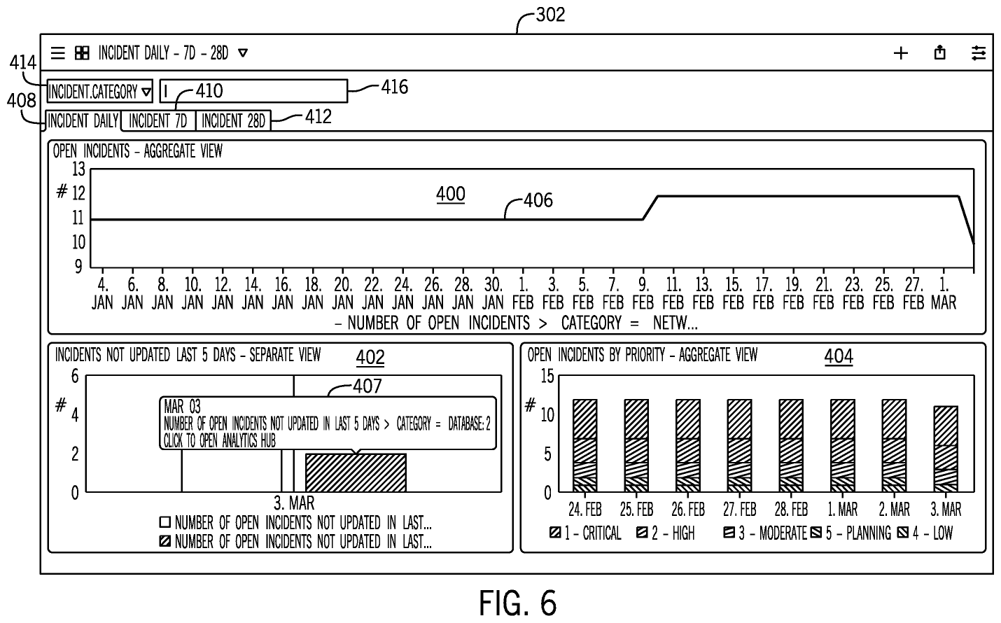

FIG. 6 is a screenshot of an embodiment of the dashboard 302. As shown, the dashboard 302 includes a first widget 400, a second widget 402, and a third widget 404. However, as previously described, the dashboard 302 may be customized to include as many or as few widgets 400, 402, 404 as the user prefers. Further, the type of widgets 400, 402, 404, the sizes of the widgets 400, 402, 404, and the positions of the widgets 400, 402, 404 may be customized by the user.

In the instant embodiment, the first widget 400 is a visualization showing a time series plot of the number of open incidents by day, wherein a line 406 indicates the total number of open incidents on a given day. The second widget 402 is a visualization showing the total number of incidents that have not been updated in the previous 5 days. The third widget 404 displays the number of open incidents on a given day, broken out by priority. Within the third widget 404, for each day, a column is shown. The height of the column indicates the total number of open incidents on that day. Each block of color within the column indicates the number of open incidents given a specific priority designation. As shown, moving a cursor or a mouse icon over parts of the widgets 400, 402, 404 may cause a pop-up window 407 to open, displaying additional information about this part of the widget 400, 402, 404.

Further, the dashboard 302 may include tabs, selectable by the user to display various sets of widgets. In the illustrated embodiment, the incident daily 408 tab is selected and first, second, and third widgets 400, 402, 404 are shown. However, selection of an incident 7d tab 410 or an incident 28d tab 412 may cause other sets of widgets to be displayed. As with the widgets, the names and orders of the tabs 408, 410, 412 may be customizable by a user.

The dashboard 302 may also include a breakdown element group field 414 and a breakdown element field 416. Breakdown elements are categories by which the underlying data may be broken down. These breakdown elements may be separated into groups. For example, in the instant embodiment, incident category has been selected in the breakdown element group field 414. These incident categories may include, for example, breakdown elements of inquiry, software, hardware, network, database, etc. Other breakdown element groups may include, for example, age of incident, priority of incident, team assigned to incident, etc. Once a breakdown element group has been selected from a drop down menu, upon selecting the breakdown element field 416, the options for breakdown elements may be displayed.

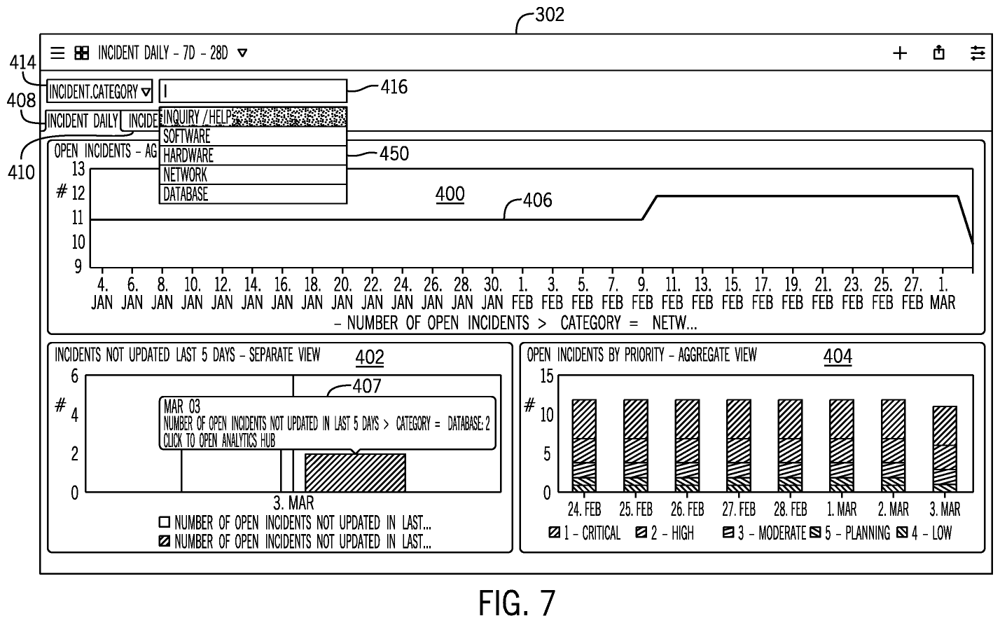

FIG. 7 is a screenshot of an embodiment of the dashboard 302 shown in FIG. 6 with the breakdown element field 416 selected. As shown, once the breakdown element field 416 is selected, a drop down menu 450 may appear displaying the various breakdown element options. The user may select a breakdown element via the dropdown menu 450. Once a breakdown element is selected, the breakdown element appears in the breakdown element field 416.

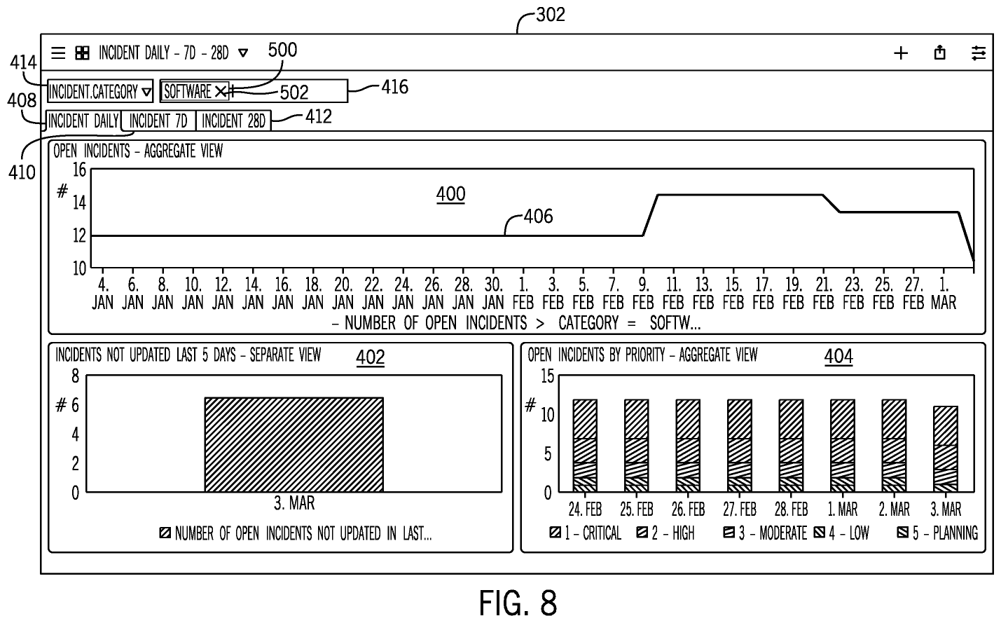

FIG. 8 is a screenshot of an embodiment of the dashboard 302 shown in FIGS. 6 and 7 with a software breakdown element 500 selected. Once one or more breakdown elements are selected, the widgets are updated to reflect the selected breakdown element or elements. For example, in FIG. 8, because the software breakdown element 500 is selected, the widgets 400, 402, 404 have been updated to only show data for incidents related to software. As shown, the software breakdown element 500 appears within the breakdown element field 416. The software breakdown element 500 includes a remove button 502, which allows a user to easily unselect the breakdown element. By selecting the breakdown element field 416 again, a user may select an additional breakdown element.

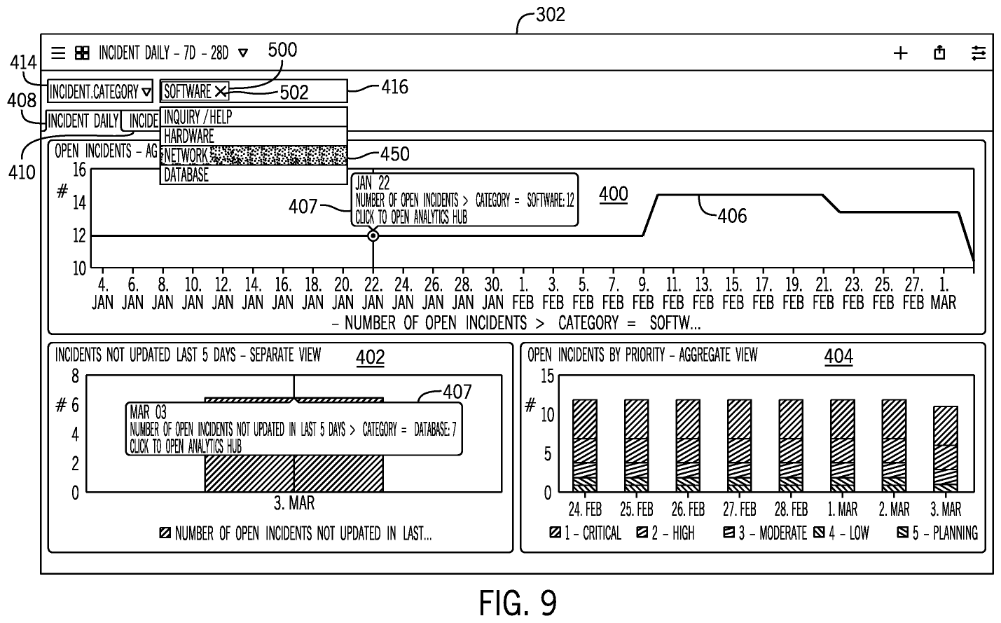

FIG. 9 is a screenshot of an embodiment of the dashboard 302 shown in FIGS. 6-8 with the software breakdown element 500 selected and breakdown element field 416 selected. As illustrated, the drop down menu 450 appears and displays the remaining unselected breakdown elements within the selected breakdown elements group. The user may select one of the remaining breakdown elements from the drop down menu 450 in order to add another breakdown element.

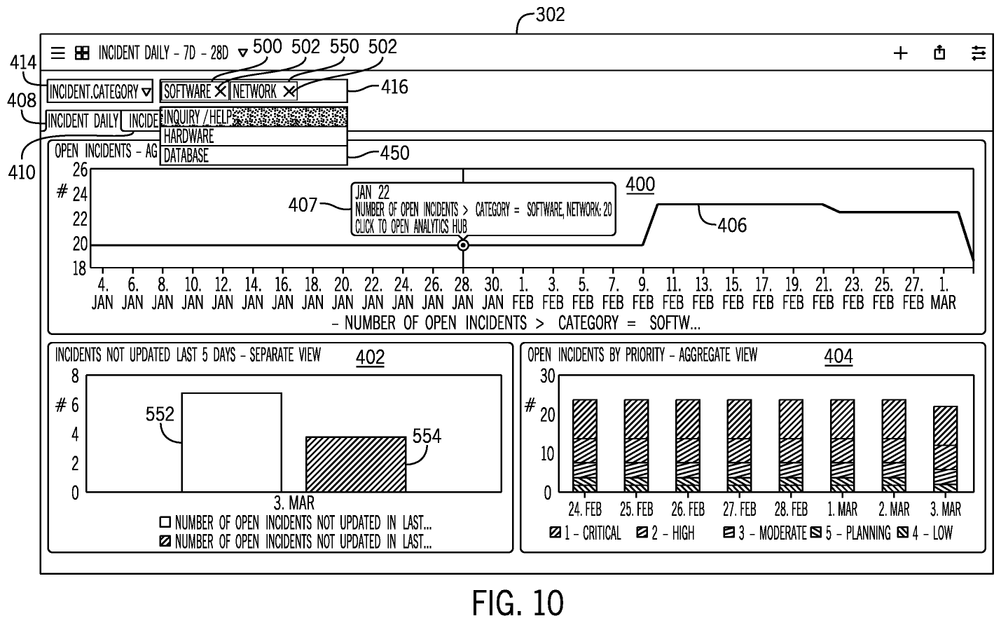

FIG. 10 is a screenshot of an embodiment of the dashboard 302 shown in FIGS. 6-9 with the software breakdown element 500 and a network breakdown element 550 selected, as well as the breakdown element field 416. Upon selection of the network breakdown element 550 (in addition to the software breakdown element 500), the widgets 400, 402, 404 have been updated to only show data for incidents related to software and networks.

It should be understood that each of the widgets 400, 402, 404 may be set to display as a separate view or an aggregate view as multiple breakdown elements are selected. For example, the first widget 400 is set to display an aggregate view, so as multiple breakdown elements are selected, the widget displays the total number of open incidents that fall into one or more of the selected categories. That is, the line 406 indicates the total number of open incidents on a given day that are related to software or networks.

Alternatively, the second widget 402 is set to display a separate view, so as multiple breakdown elements are selected, the widget displays a separate column for each of the selected categories. That is, second widget includes a first column 552 that represents that number of software-related incidents that have not been updated in the 5 previous days and a second column 554 that represents the number of network-related incidents that have not been updated in the 5 previous days.

As illustrated, the drop down menu 450 appears and displays the remaining unselected breakdown elements within the selected breakdown elements group. The user may select one of the remaining breakdown elements from the drop down menu 450 in order to add another breakdown element.

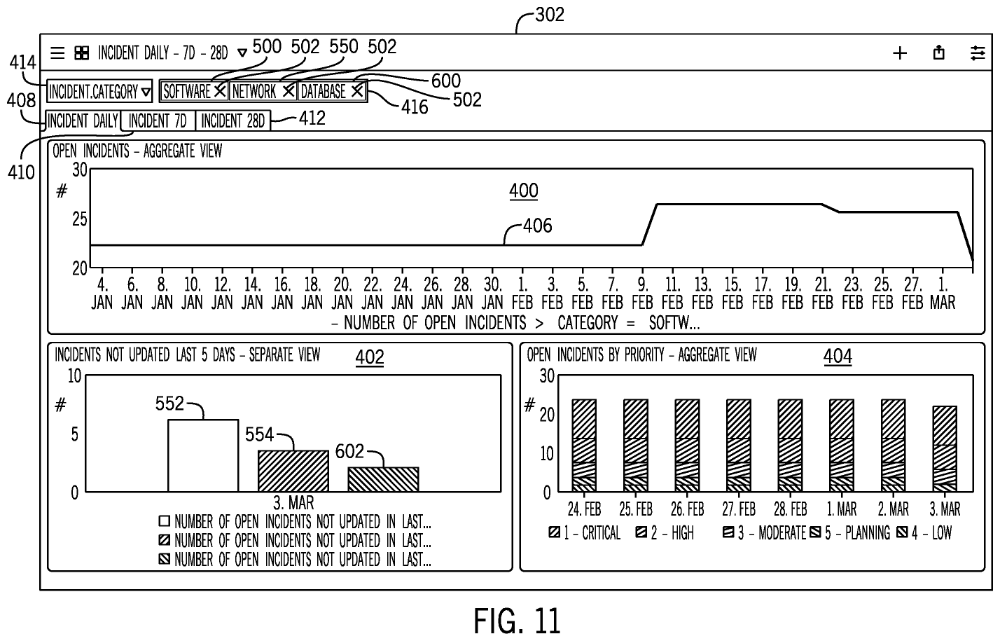

FIG. 11 is a screenshot of an embodiment of the dashboard 302 shown in FIGS. 6-10 with the software breakdown element 500, the network breakdown element 550, and the database breakdown element 600 selected. Upon selection of the database breakdown element 600 (in addition to the software breakdown element 500 and the network breakdown element 550), the widgets 400, 402, 404 have been updated to only show data for incidents related to software, networks, and databases. For example, in the first widget 400, the line now represents the total number of open incidents on a given day that are related to software, networks, and/or databases. Similarly, the second widget 402 still includes the first column 552 and the second column 554, but has added a third column 602 representing the number of database-related incidents that have not been updated in the 5 previous days.

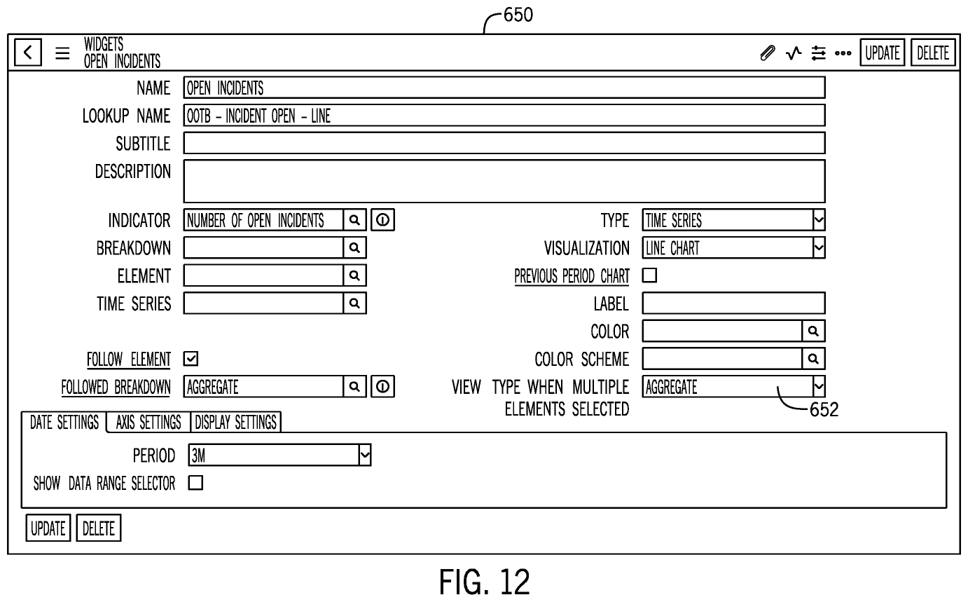

As previously discussed, each of the widgets 400, 402, and 404 may be set to display an aggregate view or a separate view when multiple breakdown elements are selected. FIG. 12 is a screenshot of a widget definition interface 650, by which a user may define one or more aspects of a widget, including whether the widget displays an aggregate view or a separate view when multiple breakdown elements are selected. As illustrated, the widget definition interface 650 includes a view type field 652. Selecting the view type field 652 may cause a drop down menu to appear. The user may then select an aggregate view type or a separate view type from the drop down menu.

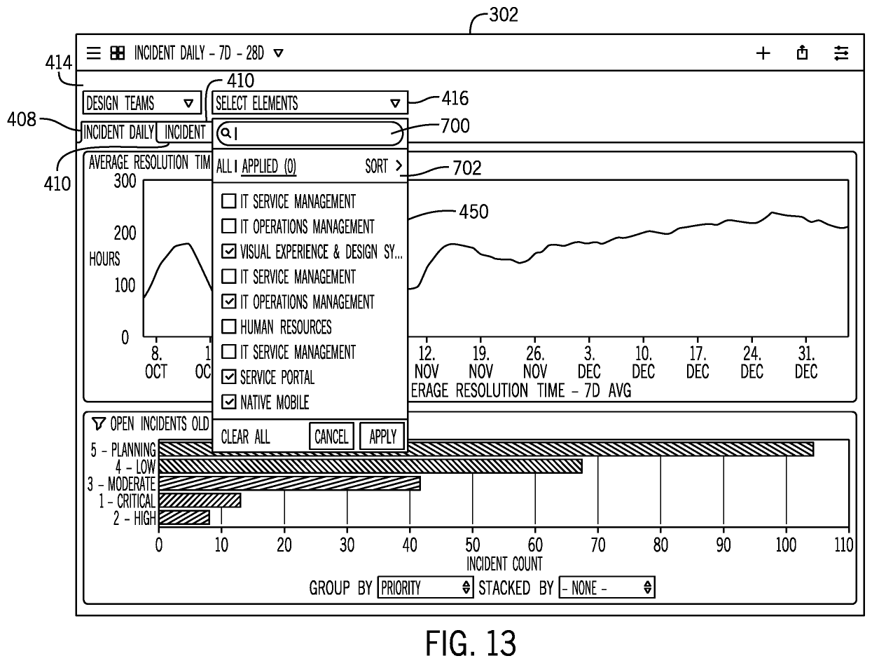

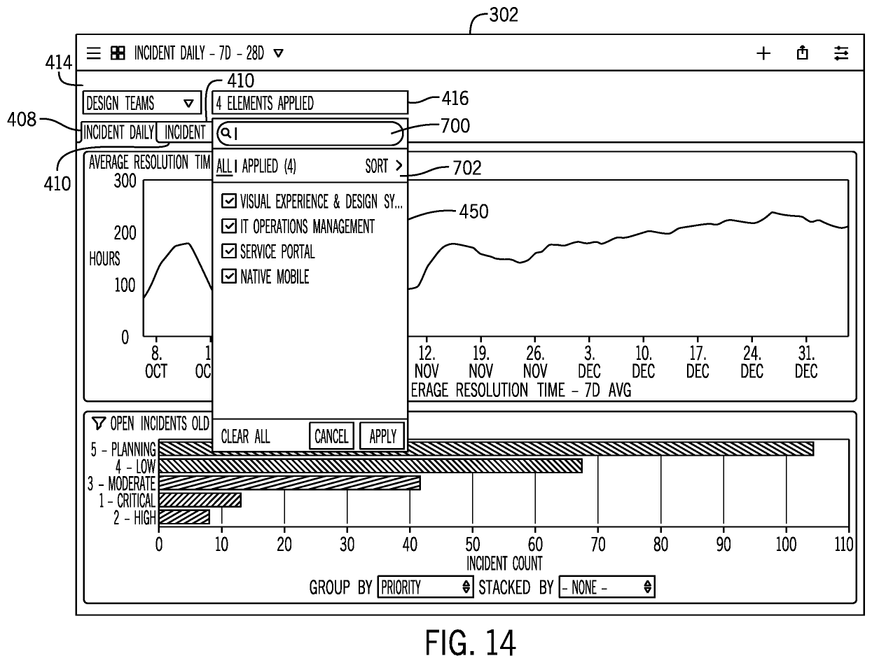

FIGS. 13 and 14 illustrate an alternate embodiment for displaying breakdown elements within the dashboard 302. FIG. 13 illustrates an embodiment of the dropdown menu 450 that appears when the breakdown element field 416 is selected. As shown, the drop down menu 450 includes a search bar 700 that allows a user to search for breakdown elements and a sort bar 702 that allows a user to sort breakdown elements. In the embodiments of the dropdown menu 450 shown and described with regard to FIGS. 7-10, already selected breakdown elements were removed from the dropdown menu 450. However, in the embodiment of the drop down menu 450 shown in FIG. 13, the selected breakdown elements remain in the dropdown menu 450 when selected, but have a check mark indicating that they have been selected. When “all” is selected in the sort bar 702, all of the available breakdown elements are displayed in the dropdown menu 450.

FIG. 14 illustrates an embodiment of the dropdown menu 450 that appears when the breakdown element field 416 is selected and the “applied” option is selected in the sort bar 702. As shown, when the “applied” option is selected in the sort bar 702, only the selected breakdown elements are displayed.

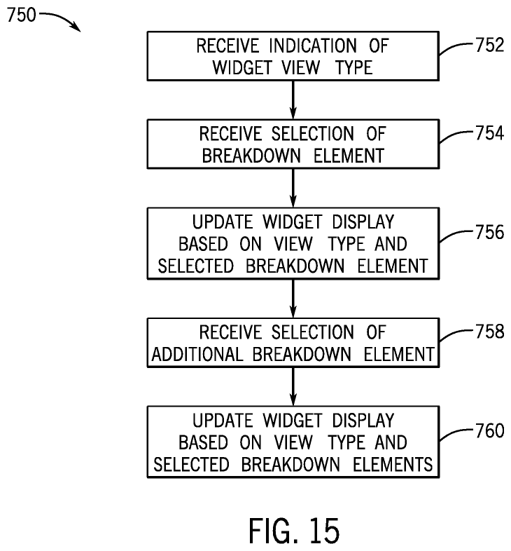

FIG. 15 is a flow chart of a process 750 for updating a widget based on selection of breakdown elements. At block 752, the process 750 receives an indication of a widget view type. In some embodiments, the widget view type may be stored in memory and retrieved rather than received. This may include, for example, an aggregated view or a separate view. At block 754, the process 750 receives selection of a breakdown element. At block 756, the process 750 updates the widget based on the widget view type and the selected breakdown element. At block 758, the process 750 receives selection of an additional breakdown element. At block 760, the widget is updated based on the widget view type and the selected breakdown elements. If another breakdown element is selected, the process may return to block 758 and receive the additional breakdown element and then update the widget accordingly based on the widget view type and the selected breakdown elements (block 760).

The disclosed techniques include receiving selection of multiple breakdown elements and updating a visualization within the widget based on the selected breakdown elements. The widget may have an aggregate view type or a separate view type. In the aggregate view type, data associated with the selected breakdown elements is combined into a single plot. In the separate view type, data associated with the selected breakdown elements is kept separate and shown in separate respective plots. The widget may be part of a dashboard having multiple widgets. The dashboard may include some widgets having an aggregate view type and other widgets having a separate view type.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processor; and
a memory, the memory storing instructions that, when executed by the processor, cause the processor to:
receive indication of a widget view type;
receive selection of a first breakdown element;
update a widget based on the widget view type and the first breakdown element;
receive selection of a second breakdown element; and
update the widget based on the widget view type, the first breakdown element, and the second breakdown element.

2. The system of claim 1, when in the instructions, when executed by the processor, cause the processor to:
receive selection of a third breakdown element; and
update the widget based on the widget view type, the first breakdown element, the second breakdown element, and the third breakdown element.

3. The system of claim 2, when in the instructions, when executed by the processor, cause the processor to:
receive selection of a fourth breakdown element; and
update the widget based on the widget view type, the first breakdown element, the second breakdown element, the third breakdown element, and the fourth breakdown element.

4. The system of claim 1, wherein the widget view type comprises an aggregate view type or a separate view type.

5. The system of claim 4, wherein the aggregate view type aggregates data associated with the first breakdown element and the second breakdown element into a single plot.

6. The system of claim 4, wherein the separate view type separates data associated with the first breakdown element and the second breakdown element into first and second respective plots.

7. The system of claim 1, wherein the widget is one of a plurality of widgets within a dashboard.

8. A method, comprising:
receiving indication of a widget view type, wherein the widget view type comprises an aggregate view type or a separate view type;
receiving selection of a first breakdown element;
updating a widget based on the widget view type and the first breakdown element;
receiving selection of a second breakdown element; and
updating the widget based on the widget view type, the first breakdown element, and the second breakdown element.

9. The method of claim 8, comprising:
receiving selection of a third breakdown element; and
updating the widget based on the widget view type, the first breakdown element, the second breakdown element, and the third breakdown element.

10. The method of claim 9, comprising:
receiving selection of a fourth breakdown element; and
updating the widget based on the widget view type, the first breakdown element, the second breakdown element, the third breakdown element, and the fourth breakdown element.

11. The method of claim 8, wherein the aggregate view type aggregates data associated with the first breakdown element and the second breakdown element into a single plot.

12. The method of claim 8, wherein the separate view type separates data associated with the first breakdown element and the second breakdown element into first and second respective plots.

13. The method of claim 8, comprising generating the widget for display.

14. The method of claim 8, wherein the widget is one of a plurality of widgets within a dashboard.

15. A non-transitory, computer readable medium, storing instructions that, when executed by a processor, cause the processor to:
generate a widget for display;
receive selection of a first breakdown element;
update the widget based on a widget view type and the first breakdown element, wherein the widget view type comprises an aggregate view type or a separate view type;
receive selection of a second breakdown element; and
update the widget based on the widget view type, the first breakdown element, and the second breakdown element.

16. The non-transitory, computer readable medium of claim 15, storing instructions that, when executed by the processor, cause the processor to:
receive selection of a third breakdown element; and
update the widget based on the widget view type, the first breakdown element, the second breakdown element, and the third breakdown element.

17. The non-transitory, computer readable medium of claim 16, storing instructions that, when executed by the processor, cause the processor to:
receive selection of a fourth breakdown element; and
update the widget based on the widget view type, the first breakdown element, the second breakdown element, the third breakdown element, and the fourth breakdown element.

18. The non-transitory, computer readable medium of claim 15, wherein the aggregate view type aggregates data associated with the first breakdown element and the second breakdown element into a single plot, and wherein the separate view type separates data associated with the first breakdown element and the second breakdown element into first and second respective plots.

19. The non-transitory, computer readable medium of claim 15, wherein the widget is one of a plurality of widgets within a dashboard.

20. The non-transitory, computer readable medium of claim 19, wherein the plurality of widgets within the dashboard include a first widget of the aggregate view type and a second widget of the separate view type.
